(19) United States
(12) Patent Application Publication
(10) Pub. No.: US 2004/0100483 A1
(43) Pub. Date: May 27, 2004

(54) Index structure process

(76) Inventor: Lucian Russell, Alexandria, VA (US)

Correspondence Address: Lucian Russell, 6012 Jewell Court, Alexandria, VA, 22312, US

(21) Appl. No.: 10/105,928

(22) Filed: Oct. 2, 2002

(51) Int. Cl. G09G 5/00

(52) U.S. Cl. 345/719

(57) ABSTRACT

This invention is a process to create an index structure for 2-dimensional shapes that improves the performance of processes that match the outlines of shapes processed in image.

### 1.0 BACKGROUND

Collections of digital images are common to many applications in industry and government. These collections are often put under the control of a single piece of software and defined as a database of images. The images can even be stored in commercially available database Management Systems (DBMSs). This does, not, however, mean that the standard type of operations such as retrieving the images by their content can be performed. In fact, querying databases of images to find one or more images of interest is an area of ongoing research and development. Theoretical models of how such databases might be queries can be found in textbooks [Sub 98] but practical products do not yet exist.

The first set of reasons that this is impossible is that as a data type a record is just descriptions a files whose fields (Pixels) are adjacent points of differing colors. Because the files have no inherent meaning, all approaches presume that the images are either (1) put into the database with a large amount of query-able text or numeric data, or else (2) the subject of some processing by subsidiary computer programs which in turn creates some related alphabetic or numeric data.

Section 2 describes the state of Current understanding of image processing that applies to shape detection in images. There is another technology related to texture which is not of interest in this setting. Neither are algorithms that ate used to infer if specific shoes—e.g. tanks—are in an image, so these are not discussed. Section 2.1 provides an overview of the general issues of processing image databases. For databases of images to be useful additional related data must be supplied, wither explicitly at the time they are added or else implicitly by means of some special purpose algorithms. The choice of algorithms is determined by the type of query that is to be made. The results are a set of features that are used for exact or similarity queries. Section 2.2 describes the issues associated with describing shapes in images and describes the state of the art. Section 3 describes the new techniques used for indexing shapes.

### 2.0 ISSUES OF QUERYING IMAGE MULTIMEDIA DATA

Image data is quite different from standard alphanumeric data, both from a presentation as well as from a semantics point of view. Image data may contain embedded alphanumeric (e.g. a scanned image of a handwritten letter), graphics (human drawn diagrams), and pictures, which may be photographs, drawings, paintings etc..

2.1 Querying Issues

Querying requires a computer accessible representation of the content of image data items. This means that there may be many complex processing algorithms that need to be applied to extract an image's semantics from its raw data form. The real-world objects, shown in pictures or graphics, also may be depicted participating in meaningful events, whose nature is often the actual subject of queries. Utilizing state-of-the-art approaches from the fields of image interpretation it is often possible to extract information from images that is less complex and voluminous than the images themselves. This data can give some clues as to the semantics of the events being represented by these objects. This information consists of objects called features, which are used to recognize similar real-world objects and events in a collection of images. These are stored together with the images and constitute the queryable collection of data. The nature of the extracted features and their data structure representation will greatly influence the effectiveness of this process.

2.2 Querying via Similarities

Querying in an image database system is quite different from querying in standard alphanumeric databases in that the results of these queries are not expected to be perfect matches but results that are close to the designated criteria based upon some measure of similarity. Besides the fact that browsing takes on added importance in a multimedia environment, queries may contain multimedia objects of various sorts input by the user, which in turn must also be pre-processed to extract features.

Given the presence of an image repository connected to a database system, a user typically initiates exploratory browsing interspersed with queries of various kinds. These queries would typically be of the sort that ask for the description of the real-world object, o, corresponding to a semcon (semantic icon) [Gro97], s, initiated by clicking the mouse over s, as well as navigating to other multimedia objects containing semcons similar to s or whose represented real-world objects are in some relationship to o.

If the location of a semcon is known within the image, this can be recorded in indexes suited to dividing an image into smaller segments. Such indexes like R-trees are discussed in [Subr 98]. For cases where the location is not known the question how to approach it is more complex. Queries which entail the retrieval of images having a certain property, such as depicting a desert scene, or containing a representation of a real-world entity that is also represented in a different image, cannot be efficiently implemented in a standard database system. Examples of the latter type of query are,

1. Query 1: Retrieve all photographs showing politician X giving a speech, given a photograph of the politician

2. Query 2: Show me all mug shots of criminals who resemble this artists sketch.

The results of these types of queries are based on similarity matches, not exact matches. What are actually being searched for are images corresponding to the same real-world object. It is extremely rare, however, that two images, for example, of the same person match in an exact manner. Similarity measures between two multimedia objects are usually real-valued and range from 0 (completely different) to 1 (exactly the same). The similarity of two images is actually derived from matching their corresponding feature sets.

Theoretically, the result of query 1 above should be all photographs in the entire database, each one ranked from 0 to 1 for its similarity to a shot of the particular politician giving a speech, and the result of query 2 should be all images in the entire database, each one ranked from 0 to 1 for its similarity to the given sketch. In practice, however, there is a specified threshold such that if the ranking of a given image is less than this value, it is not retrieved. The implementations of these operations usually consist of the use of a specialized index via a filtering operation to remove below threshold images from further consideration followed by an ordering based on the rank of the images that are left.

Indexes of standard database systems, however, are designed for the standard data types of integers, decimal numbers, floating point numbers, and character strings, as well as for some date and time data types. They are one-dimensional and are usually hash-based or utilize some of the B-tree variants. In most cases, they are unsuitable for similarity matching.

Generally, there is more than one way to answer a particular query in an image oriented information system. For example a database system might translate a complex query specified through the mediation of some advanced user interface into an SQL query containing user-defined functions and operators. An example function would be desert_scene, which takes as an argument an image and returns true iff the similarity of the image to a desert scene is above some fixed threshold. In order to do intelligent query optimization with the presence of user-defined functions and operators. There has not been much work done in query processing optimization for multimedia information systems. An exception is [ChG96], which discusses this problem in the environment of the following storage-level access functions:

1. GradeSearch(att, val, min_threshold), which returns all multimedia objects where the similarity of the value of attribute att to the value val is at or over the threshold min threshold.

2. TopSearch(att, val, count), which returns the count multimedia objects having the highest similarity of the attribute att to the value val.

3. Probe(att, val, (oid}), which returns the similarity for object o of the value of its attribute att to the value vat, for each object o whose object identifier is a member of the set {oid}.

This approach is tailor-made to the nearest-neighbor indexing methodologies discussed above, which is quite fortuitous, as this approach to representing multimedia objects also lends itself to such data mining and knowledge discovery techniques as various clustering methodologies. The disadvantages of this approach, however, are that the dimensionality of many multimedia objects are quite large and the fact that multimedia objects from different domains have incomparable features and different dimensionalities. The first disadvantage may be overcome, however, by various dimensionality-reducing techniques [DuH73]. The second disadvantage is more serious, and its implications won't be fully appreciated before we have much more experience in data mining and knowledge discovery of multimedia data.

1.2 Shapes in Images

The discussion that follows excerpts from a report submitted to the U.S. Air Force. It provides a description of how shapes in images can be represented. It is the basis of the technology that is improved by the invention.

1.1.2 Introduction

The traditional database approach of modeling the real world is based on manual annotations of its salient features in terms of alphanumeric data. For example, an image is manually annotated by identifying the photographer, time, place, and participating objects. However, all such annotations are limited and subjective in nature, and they are often difficult or impossible to use to describe certain important real-world concepts, entities, and attributes. The shape of a single object and the various spatial constraints among multiple objects in an image are examples of such concepts. Shape and spatial constraints are important data in many applications, ranging from complex space exploration and satellite information management to medical research and entertainment.

Like traditional databases, image databases are also required to provide support for user queries under specific constraints and selection conditions. In [GrJ94], image retrievals have been categorized into exact retrievals and similarity-based retrievals. For both types of retrievals, image databases involve feature matching techniques in order to retrieve relevant database images against a given query image. In most cases, such retrievals are computationally expensive and require sophisticated methodologies involving image processing and database techniques. To overcome these problems, symbolic image representations have been used [ChL84]. A symbolic image is an abstraction of a physical image, providing physical and logical data independence. Symbolic images are generally used in conjunction with index structures as proxies for image comparisons to reduce the search space. Once a measure of similarity is determined, the corresponding actual images are retrieved from the database. Even though there is now a standard description of metadata for images (see [MPE97] for information on the MPEG-7 standard), there is still no single standard of image representation, storage, and no standard measure for similarity.

For data modeling and image representation, several schemes have been proposed [ATY95, ChW92, CSY86, Gud95, HuJ94]. Each of these schemes builds a symbolic image from a given physical image for similarity-based retrievals. All of these techniques, in one respect or another, depend on geometrical transformations such as scaling, translation, and rotation of the image. In addition, some of these schemes require normalization or restrict the size of an image [ATY95, BPS94], and in some cases, also lack an indexing mechanism.

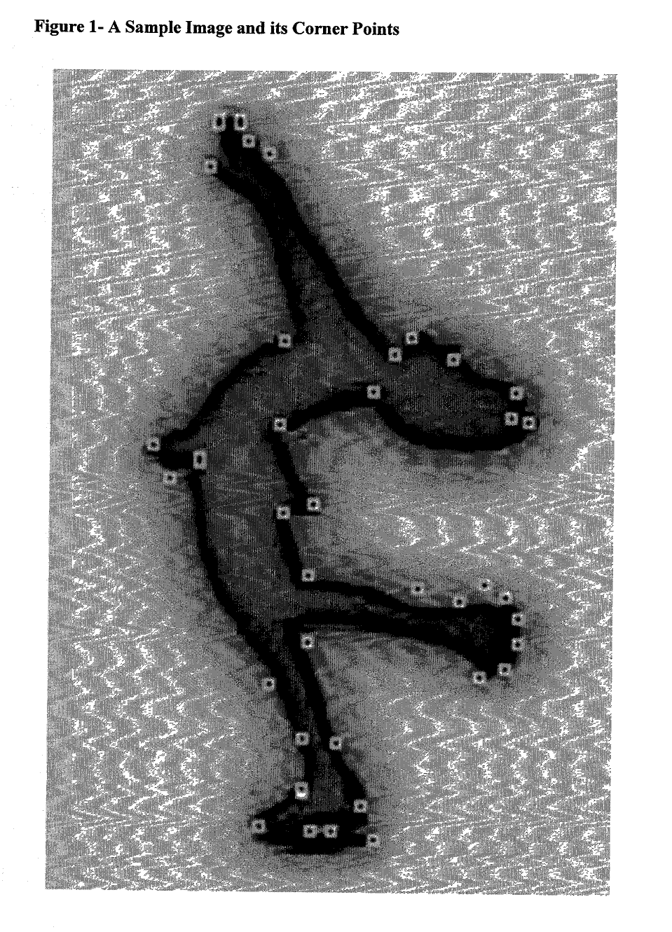

The basis for the indexing approach described in Section 3 is as a spatial arrangement of features. Many features can be represented by labeled points with a given location in space. For example, a corner point of an image region has a precise location and can be labeled with the region's identifier, and a color histogram of an image region can be represented by a point placed at the center-of-mass of the region and labeled by the histogram. Thus, an image region can be represented by a set of labeled 2-D points, consisting, for example, of all its corner points (see FIG. 1).

The remainder of the paper is organized as follows. Section 1.2.2 presents an overview of the results of applying the similarity searches for searches in the experimental object-based image retrieval (OBIR) system developed at Wayne State University. Sections 1.2.3 and 1.2.4 describe the histogram-based approach to indexing spatial arrangements of features. The effectiveness and efficiency of the system are described by various experiments reported in Section 1.2.5. Section 1.2.6 presents some concluding remarks. The system's effectiveness shows that a robust system of indexing shapes could be used practically. Section 3 describes the improvement that is the invention.

1.2.2 Design and Implementation of OBIR

1.2.2.1 System Diagram

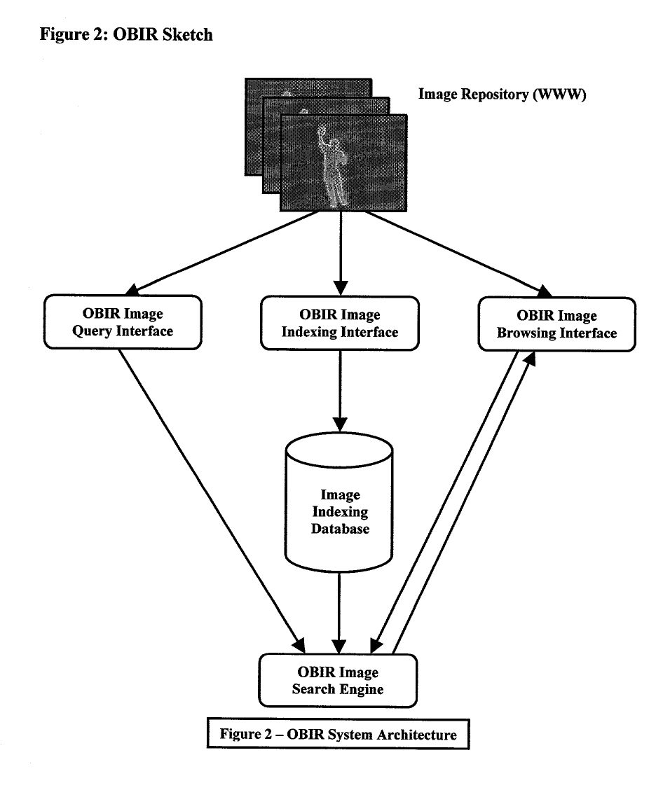

A diagram of the system is shown in FIG. 2

1.2.2.2 Image Query Interface

This component of the system allows users to flexibly query the image database by simply clicking and moving the mouse in the query specification window to select or deselect shapes and spatial constraints among part or all of query image objects. The selected image objects are visually similar to the shapes and satisfy the spatial constraints of those objects wanted in the user's mind. This permits users to query the system based on the contents of an image without forcing them to know the exact values of the image features. This query image specification approach is well supported by the new image indexing structure, which will be described shortly.

1.2.2.3 Image Browsing Interface

This component of the system displays the top ranked images among the query results. Any returned image can be used as the basis for subsequent queries. In addition, this component allows users to utilize metadata to intelligently browse indexed images. The assumption that any information about the image which can be used to infer information regarding its content is an example of content-based metadata. Thus, a collection of metadata that corresponds to those indexed images is integrated into this component to support metadata mediated browsing, which is discussed in detail in [GFJ97].

1.2.2.4 Image Search Engine

This component of the system interacts with the image index database to access stored visual features of indexed images. Upon the request of the image query interface or the image browsing interface, this component finds matching image objects using a similarity measure based on shape and spatial relationships. Several similarity functions may be defined for different requests. A number of top-ranked image URLs and their corresponding similarity values are returned according to a predefined threshold value. The images are stored in the files with the URLs.

1.2.2.5 Image Index Database

This component of the system maintains all of the indexed image features so as to support effective and efficient image retrieval. Since the features collected in the database are computed only once through the image indexing interface, minimal processing is done during image querying or browsing.

1.2.2.6 Image Repository

This component of the system points to the repository or repositories where images are stored.

1.2.3 Feature Extraction

A symbolic image is an abstraction of a physical image. Each symbolic image Iₖ in the database is composed of a set of unique and characterizing features:

$${F}_{k} = \{ {F}_{k}^{1} , … , {F}_{k}^{{r}_{k}} \} .$$

Image features can be classified into two categories:

Global features are general in nature and depend on the characteristics of the entire image. Image area, perimeter, and major-axis direction are examples of such features.

Local features are based on the low-level characteristics of image objects or regions. The determination of local features usually requires more involved computation. Curvatures, boundary segments, and corner points are common examples of such features.

The spatial features we use in the approach can be global or local. An example of a set of global spatial features is the spatial arrangement of the collection of object centroids. Examples of local spatial features consist of the spatial arrangement of high-curvature points around the boundaries of the various image objects.

Based on the feature representation of an image, each image becomes a distinct entity, and therefore, as in traditional databases, the image database (IDB) is nothing but a collection of distinct entities. That is,

$$I D B = {\sum }_{k = 1}^{N} {I}_{k} ,$$

where N is the total number of images in the database.

In general, those image features that characterize image object shapes and spatial relations of multiple image objects, can be represented as a set of points. These points can be tagged with labels to capture any necessary semantics. Each of these individual points representing shape and spatial features of image objects is a feature point. Corner points, which are generally high-curvature points located along the crossings of image object edges or boundaries, serve as the feature points for the various experiments.

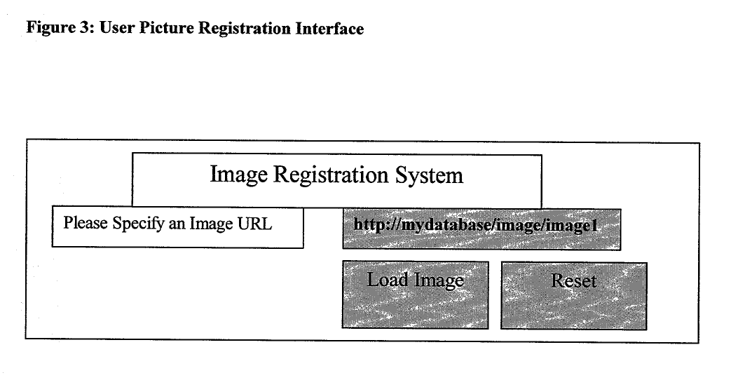

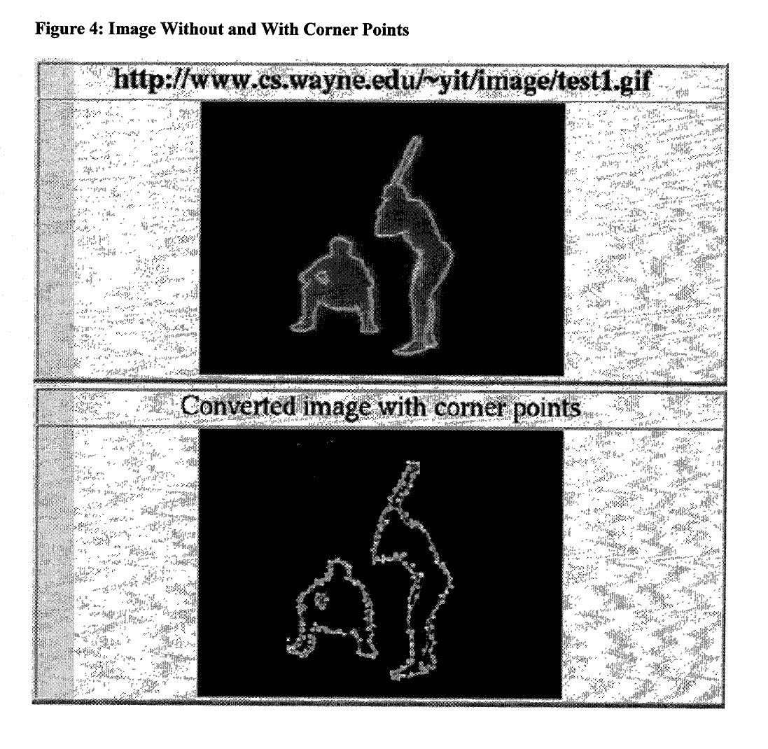

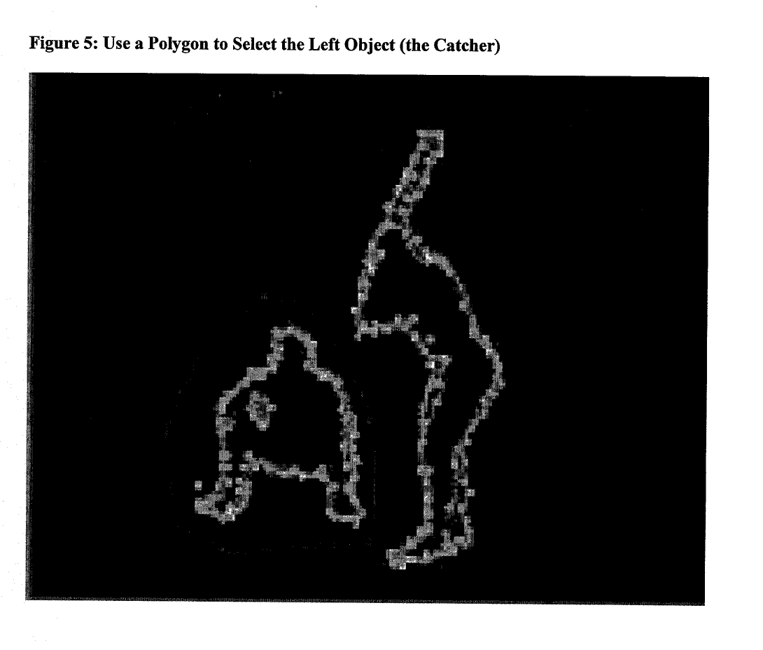

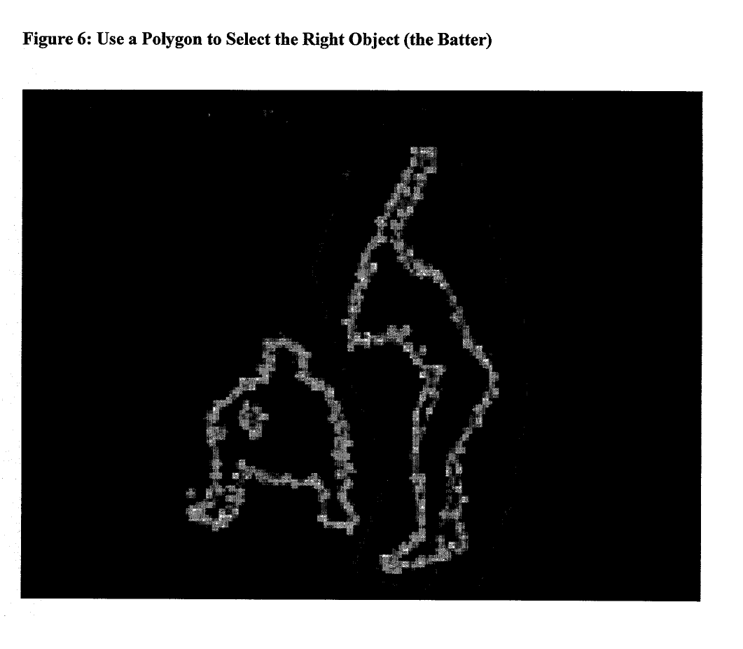

Because the OBIR system exploits indexing techniques for shape and spatial similarity-based image retrieval, it is essential to label each feature point with the information about to which image object the feature point belongs. The feature point labeling procedure can be automatic or manual, but the task of extracting and labeling individual feature points should be performed consistently for both indexed database and query images. In the OBIR system, the user is first instructed to specify the URL of the image to be indexed, as shown in FIG. 3. Then the system displays the original image and the corresponding image with marked corner points, as shown in FIG. 4. Next, as shown in the windows in FIGS. 5 and 6, the by using a mouse the user draws a polygon around each individual image object to be stored in the database. Once all points of the polygon are complete all the feature points of the chosen image object will be transformed into an index entry in the image index database and the image's URL is also stored. This is called the image object, the real world object in the image.

1.2.4 Indexing Image Objects Using Feature Point Histograms

To symbolically represent an image object in such a way that searching for variants (translation, rotation, and scaling) of the object is possible in an efficient manner. The method represents the image object by the collection of its corner points. One such technique is described in [AhG97], which works provided that the image object has been previously normalized. In the approach demonstrated herein, which is histogram-based, the image object does not have to be normalized. It also supports an incremental approach to matching, from coarse to fine (by varying the histogram bin sizes). However, as in all histogram-based methods, the representation is lossy, i.e. it is possible that different image objects have the same corresponding index object. However, to make up for this disadvantage, sub-image objects can be searched for using this approach, as opposed to the previous quadtree-based technique [AhG97], and standard nearest-neighbor approaches to indexing can be used, as a histogram can easily be represented as a multidimensional point.

The methodology is quite simple. Using the spatial arrangement of feature points, construct a Delauney triangulation [Oro94]. Then construct a histogram of the angles produced by this triangulation. Depending on the bin size, the local movement of feature points, and even the presence of outliers, affects the triangulation only locally, and thus the histogam is not appreciably changed. In principle, it is easily seen that the angles of the Delauney triangulation of a set of points remains the same under uniform translations, rotations, and scalings of this point set. For color histograms [HSE95], the histogram of a sub-image of a given image object is a sub-histogram of the histogram of the original image object. This is not technically the case with the histograms, nevertheless using this property as if it were true usually results in good sub-image matches, and approximate matches are expected in image queries. There are O(NlogN) algorithms for constructing the Delauney triangulation of a set of N points, so this method is feasible. Further, constructing the histogram corresponding to this triangulation is O(max(N, #bins) so this technique too is feasible

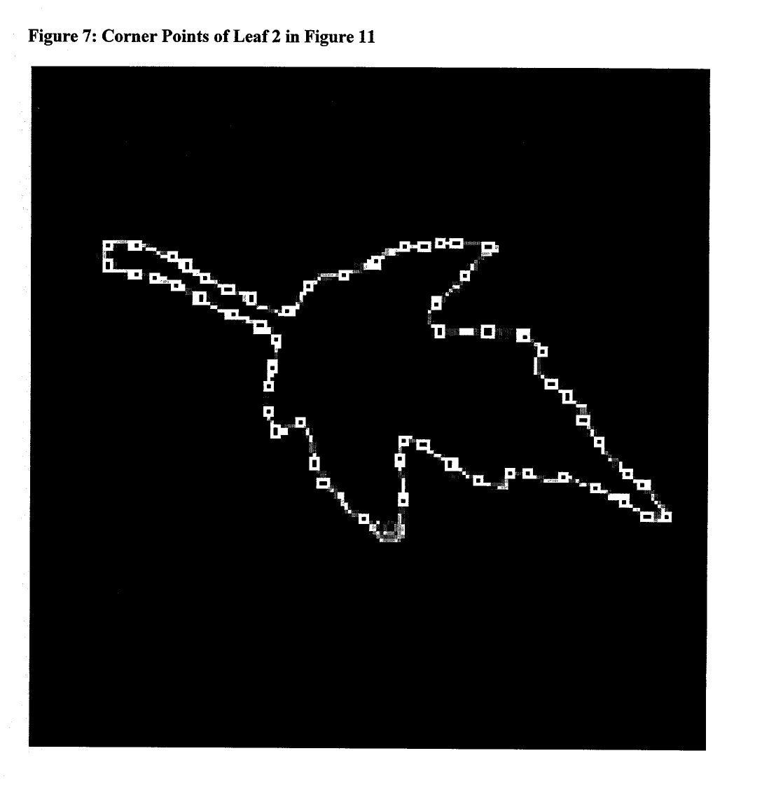

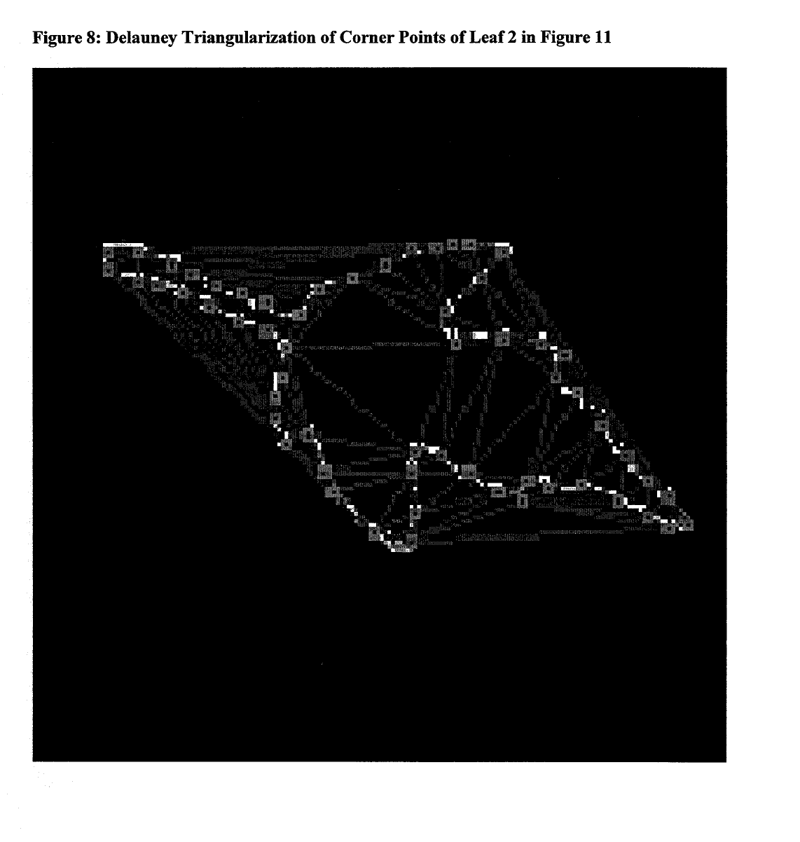

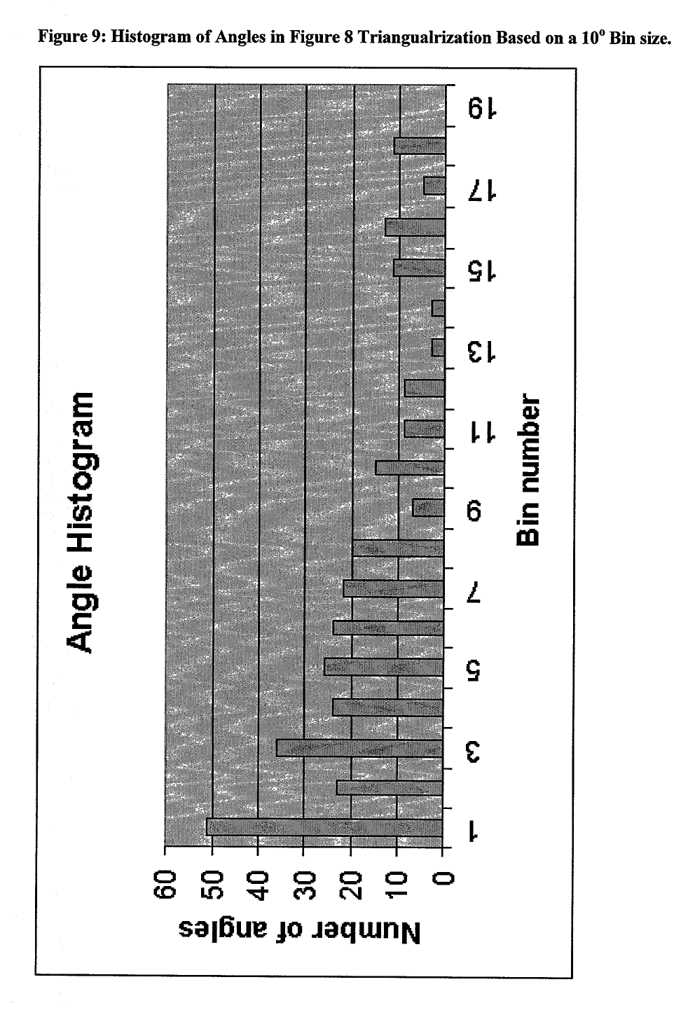

An example of the approach is shown in FIGS. 7, 8, and 9. FIG. 7 depicts an image with its corner points highlighted, FIG. 8 shows the resulting Delauney triangulation produced from these feature points, while FIG. 9 shows the resulting histogram with a bin size of 10°.

1.2.5 Experiments

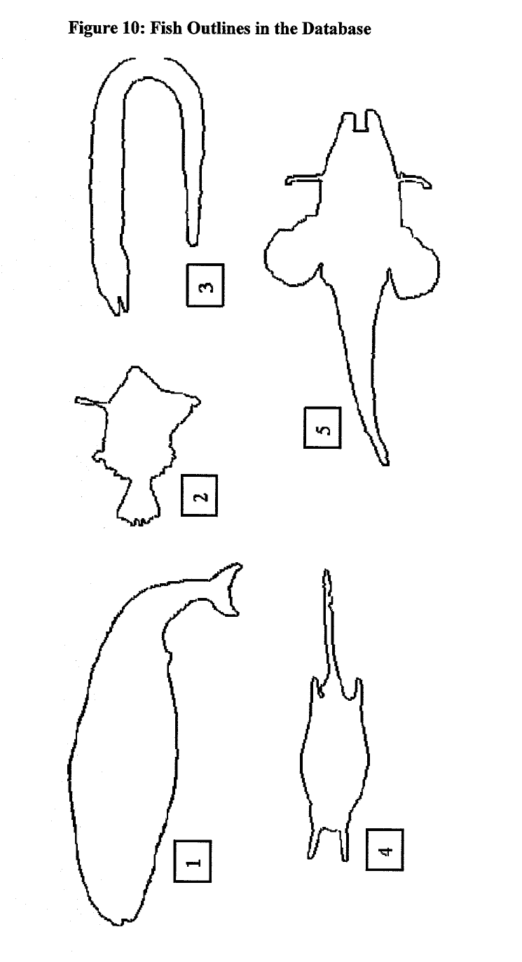

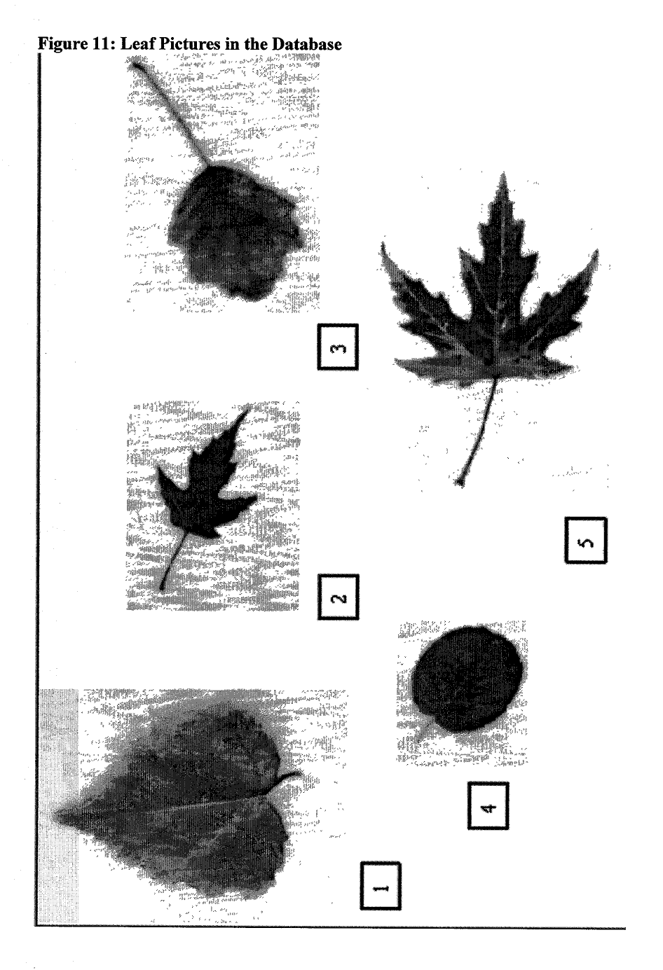

This section describes experiments conducted to demonstrate the efficacy of the approach, and hence demonstrate that the technique is practical and therefore useful. The database consists of 100 images, five original fish images shown in FIG. 10 and five original leaf images, shown if FIG. 11; each original leaf image was modified by applying operations, i.e. nine additional translation, rotation, and scaling variants of each.

For each image, the following processing steps are then taken,

Using Photoshop:

the image object is put in a square background field;

the image object is flood-filled with black, while the background is flood-filled with white.

Using Susan (discussed below) three times per image,

first with the −s option, to smooth the image;

second, with the −p option, to output an enhanced image where background pixels are black, internal pixels of the image object are black, and boundary pixels of the image object are white;

and third, with the −q (more stability), −t15 (set the brightness threshold), and −c (corner) options, to find the corner points.

The algorithm SUSAN (Smallest Univalue Segment Assimilation Nucleus) [SmB95] is used for for corner point detection. This technique is based on the concept that with each image point or pixel, a local area of similar brightness is associated. In this scheme, a circular mask of 3.4-pixel radius (mask size of 37 pixels) is used to compute the area of similar brightness and to determine the local minima for corner point detection. Each image pixel is used as the center pixel of the Gus mask, known as the nucleus, resulting in a good description of the corner points. Based on the experiments, SUSAN provides better results than traditional corner detection algorithms under varying levels of image brightness, and is also computationally efficient. Since corner detection for image feature representation is performed only once, it eliminates the repetitive tasks of low-level image processing for image content.

For each original image, there were nine variants constructed, three rotation variants, three rotation, scale-up variants, and three rotation, scale-down variants. These variants are listed in Table 1, where Fᵢ is the i^{th} fish image, Lᵢ is the i^{th}-leaf image, rot is the rotation angle in degrees, and sca is the scaling in percent

We then use each of the original ten images as a database query over the resulting database of 100 images and rank each match using the standard N-dimensional L2 metric, for N the number of bins. We evaluate the retrieval effectiveness using the standard recall-precision curves [WMB94], assuming that each image is relevant only to itself and to its nine variants.

TABLE 1
The Database of Images

| | Variants | | | | | | | | | | | | | | | | | |
|---|---|---|---|---|---|---|---|---|---|---|---|---|---|---|---|---|---|---|
| | 1 | | 2 | | 3 | | 4 | | 5 | | 6 | | 7 | | 8 | | 9 | |
| | rot | sca | rot | sca | rot | sca | rot | sca | rot | sca | rot | sca | rot | sca | rot | sca | rot | sca |
| F1 | 31 | 100 | 55 | 100 | 45 | 100 | 31 | 111 | 55 | 101 | 45 | 115 | 31 | 70 | 55 | 80 | 45 | 90 |
| F2 | 31 | 100 | 121 | 100 | 101 | 100 | 31 | 110 | 121 | 110 | 101 | 105 | 31 | 70 | 121 | 80 | 101 | 90 |
| F3 | 31 | 100 | 70 | 100 | 101 | 100 | 31 | 130 | 70 | 120 | 101 | 110 | 31 | 70 | 70 | 80 | 101 | 90 |
| F4 | 31 | 100 | 70 | 100 | 46 | 100 | 31 | 110 | 70 | 103 | 46 | 115 | 31 | 70 | 70 | 80 | 46 | 90 |
| F5 | 31 | 100 | 70 | 100 | 46 | 100 | 31 | 105 | 70 | 102 | 46 | 110 | 31 | 70 | 70 | 80 | 46 | 90 |
| L1 | 31 | 100 | 70 | 100 | 121 | 100 | 31 | 120 | 70 | 115 | 121 | 110 | 31 | 70 | 70 | 80 | 121 | 90 |
| L2 | 31 | 100 | 70 | 100 | 121 | 100 | 31 | 115 | 70 | 105 | 121 | 110 | 31 | 70 | 70 | 80 | 121 | 90 |
| L3 | 130 | 100 | 70 | 100 | 185 | 100 | 130 | 105 | 70 | 115 | 185 | 105 | 130 | 70 | 70 | 80 | 185 | 90 |
| L4 | 31 | 100 | 70 | 100 | 121 | 100 | 31 | 120 | 70 | 110 | 121 | 115 | 31 | 70 | 70 | 80 | 121 | 90 |
| L5 | 31 | 100 | 70 | 100 | 121 | 100 | 31 | 130 | 70 | 105 | 121 | 115 | 31 | 70 | 70 | 80 | 121 | 90 |

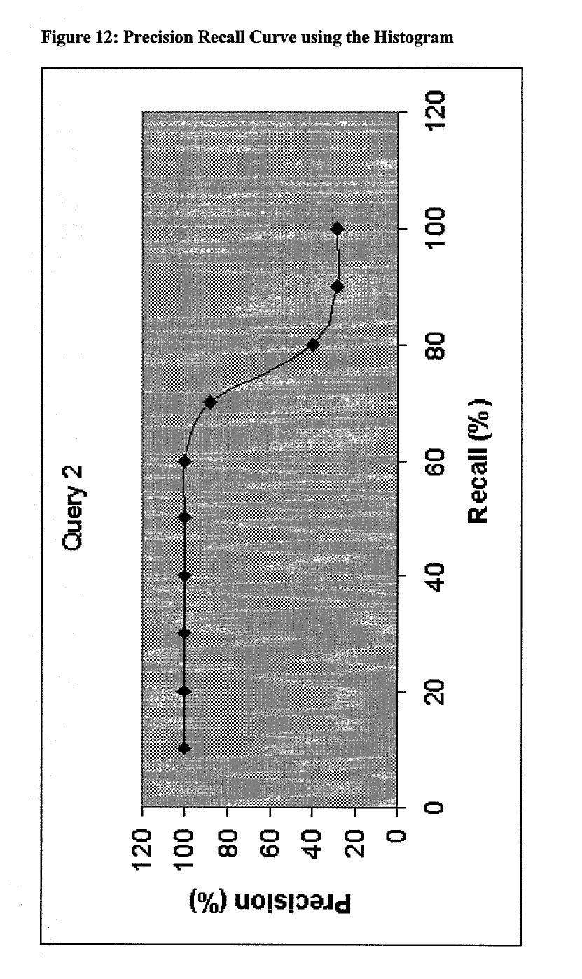

For each of the ten queries, Table 2 shows the position in the 100 retrieved database images of the ten relevant images, where relevant image i is the i^{th} relevant image retrieved. From Table 2, we may calculate recall-precision curves [WMB94]. An example curve for Query 2 is shown in FIG. 12.

TABLE 2
Position of Relevant Images for Each of Ten Queries

| Relevant | | | | | | | | | | |
|---|---|---|---|---|---|---|---|---|---|---|
| Image # | Q1 | Q2 | Q3 | Q4 | Q5 | Q6 | Q7 | Q8 | Q9 | Q10 |
| 1 | 1 | 1 | 1 | 1 | 1 | 1 | 1 | 1 | 1 | 1 |
| 2 | 2 | 2 | 2 | 2 | 2 | 2 | 2 | 2 | 2 | 2 |
| 3 | 3 | 3 | 3 | 3 | 3 | 3 | 3 | 3 | 3 | 3 |
| 4 | 4 | 4 | 4 | 4 | 4 | 4 | 4 | 4 | 4 | 4 |
| 5 | 5 | 5 | 5 | 5 | 5 | 5 | 5 | 5 | 5 | 5 |
| 6 | 6 | 6 | 6 | 6 | 6 | 6 | 6 | 7 | 6 | 6 |
| 7 | 7 | 8 | 7 | 7 | 7 | 7 | 8 | 8 | 7 | 7 |
| 8 | 8 | 20 | 8 | 8 | 8 | 12 | 9 | 9 | 8 | 8 |
| 9 | 9 | 31 | 9 | 9 | 9 | 13 | 11 | 10 | 9 | 13 |
| 10 | 10 | 35 | 10 | 30 | 20 | 22 | 25 | 38 | 12 | 48 |

Overall retrieval effectiveness is measured by using either 3-point averaging (averaging precision at recall values of 20%, 50%, and 80%) or 11-point averaging (averaging precision at recall values of 0%, 10%, 20%, 30%, 40%, 50%, 60%, 70%, 80%, 90%, and 100%). See Table 7 for a listing of these values.

TABLE 3
Retrieval Effectiveness

| Average | Q1 | Q2 | Q3 | Q4 | Q5 | Q6 | Q7 | Q8 | Q9 | Q10 |
|---|---|---|---|---|---|---|---|---|---|---|
| 3 point | 100 | 80 | 100 | 100 | 100 | 89 | 96 | 96 | 100 | 100 |
| 11 point | 100 | 79 | 100 | 93 | 95 | 88 | 90 | 88 | 98 | 89 |

### 2 An Improved Technique Indexing Shapes

Although the histogram technique is extremely good for well defined shapes, it is not so good for shapes that are approximated badly because of poor image quality. Specifically the technique depends upon the quality of the technique used to define the corner points. This section describes an indexing process, Pre-Processing and Mapping and Ordering the Triangles, that reduces the severity of that deficiency.

2.1 The Exact Case

When the shapes to be indexed. are exact and have well defined inflection points, the process of mapping the triangles to a grid of polar coordinates. This wallows a similarity grouping of triangles that have close corner point representations. Thus a more useful index will be created using the triangles in the Delauney triangularization. This is feasible because the triangularization of a shape yields a collection of triangles that can be mapped to the unit circle. This should be done to some level of approximation—an interval—because points may be on different pixels depending on the size of the object and its resolution. Although the prior experiment has some example of scaling, if the image is small in terms of the number of pixes the threshold of 3-4 neighboring pixels may not be the same for all sized images.—especially smaller ones. Therefore a scale is set: each angle must have a polar angular coordinate that is a multiple of 1°. In addition we assume that the largest angle in the triangularization is always mapped, using polar coordinates (r,θ), to the vertex at (1,0°).

This mapping allows the each triangle to be represented as a large feature vector. Large feature vectors are created and used efficiently in text retrieval applications, so the technique is fractical and effective.

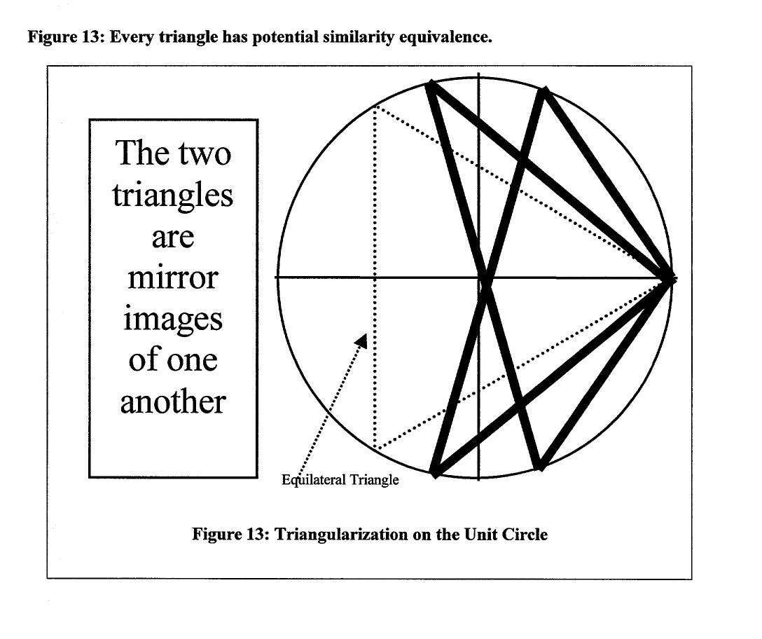

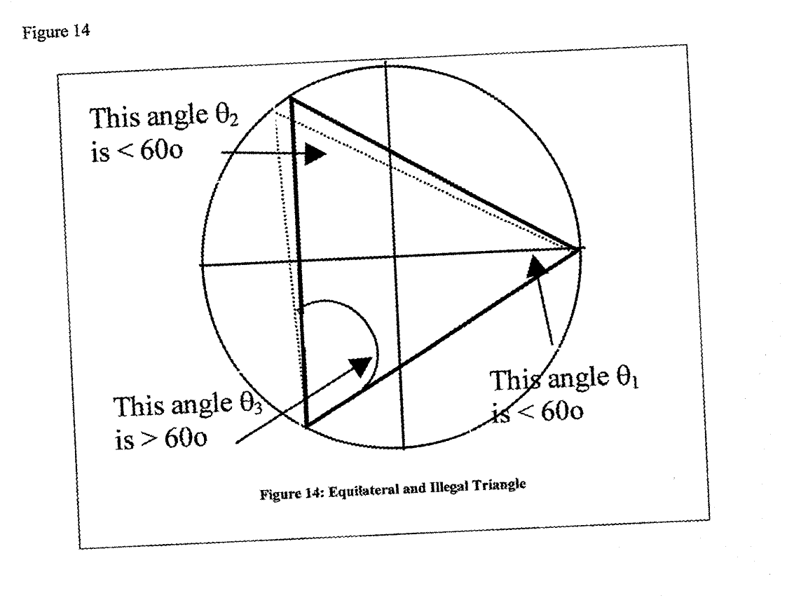

The first step is to determine the number of possible triangles. In FIG. 13 the dotted line shows the equilateral triangle, three angles of 60° with a vertex at the (1,0°) point. In polar coordinates the other angles are at the (r,θ) coordinates (1,120°) and (1,−120°). This creates a grid of 120 points on the upper part of the circle that one vertex could have, and an equal number on the lower half of the circle. However, as shown in FIG. 13, every triangle has potential similarity equivalence, i.e. every triangle with an angle of A′ on the top of the unit circle can be mapped to its mirror image at −A′ on the lower half of the circle.

The second step is to map the largest angle of the image object's Delauney triangularization triangle to the Polar Coordinates at (1, 0°). They are also constrained in number—each triangularization is appoint in 7200 dimensions:

Theorem: Under the above assumptions no triangle in the Delauney triangularization may have a vertex on the unit circle that is in the interval between r=1 and 120°<θ<240°.

The proof is by contradiction. The solid line shows the equilateral triangle, having three angles of 60°. Let the top vertex move to (1,121°). Then the angle θ₁ at the (1, 0°) point is less than 60°. However, the sum of the other two angles θ₂+θ₃>120°, which means one of them, either at (1,121°) or (1,−120°), must be greater than 60° (it is θ₃). But this is the largest angle: hence it must be at the point (1,0°). Therefore this triangle violates the constraint and is illegal. Rather it is similar to the triangle obtained by rotating the above triangle counter-clockwise by 120°. Therefore if every triangle has each vertex mapped to a point (1,n°) where n is an integer, then there are (120*120)/2=7200 possible triangles that could be mapped to the circle (if the further restriction be placed on the index that n must be an even number—2° intervals—then the number of possible triangles drops to (60*60)/2=180).

Using this information it would be possible to create a vector index. Each triangle in the Delauney triangularization would be mapped to one of the 7200 points, similarity duplicates being eliminated. Then a triangularization would be a point in a 7200-dimensional space, a technique familiar to Information Retrieval systems for text databases, i.e a document in a word space of 7200 words. Queries would then give an interval range in terms of the threshold of triangles that could be different, and further restrictions in terms of the numbers of various angle-intervals that must be matched could be added.

2.2 The Non-Exact but Convex Case

The above technique will not work, however, if the images produce different triangularizations.

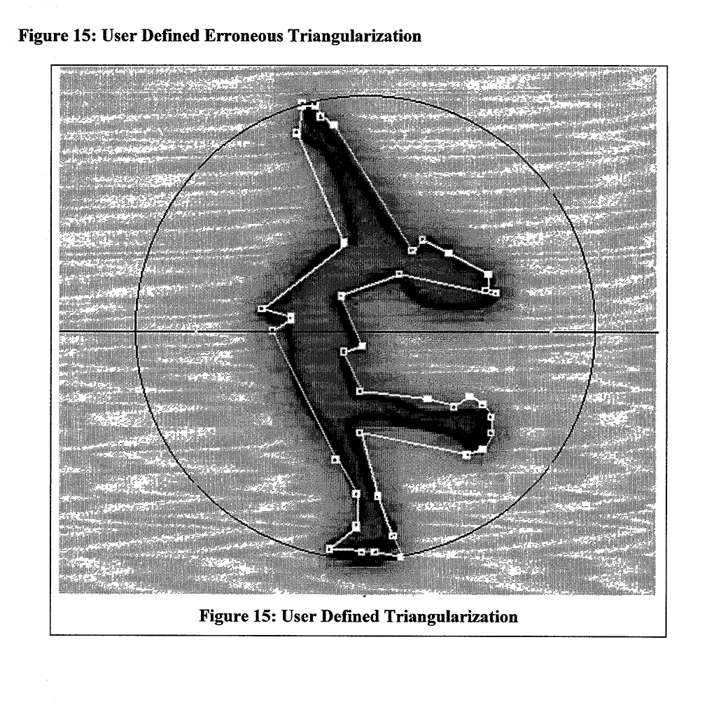

1. Consider the skater in FIG. 15 (previously shown as FIG. 11), but this time with the shape created by the user (or algorithms) who (that) that does not correctly detect the corner points (shown in white). This represents the query.

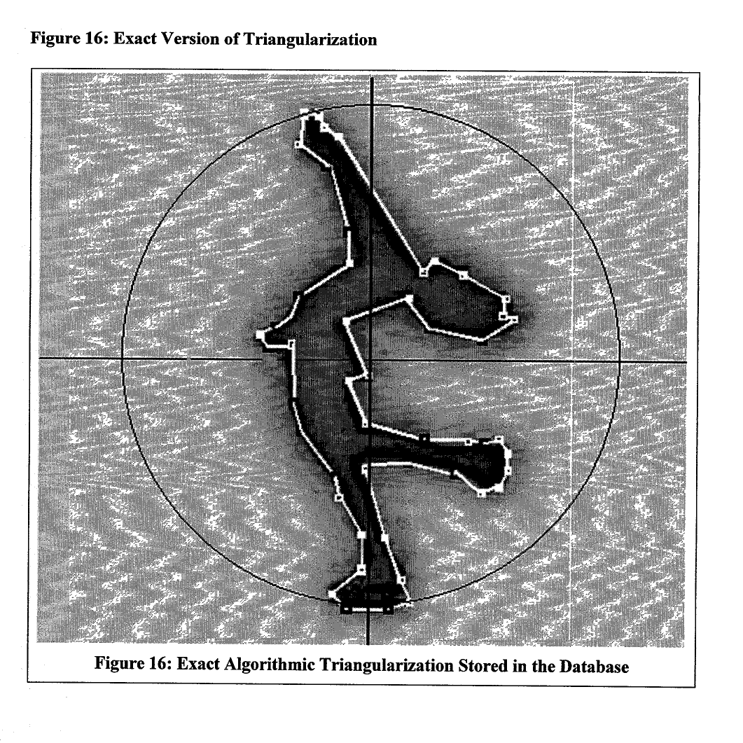

2. The better triangularization, the one stored in the database, is shown in FIG. 16.

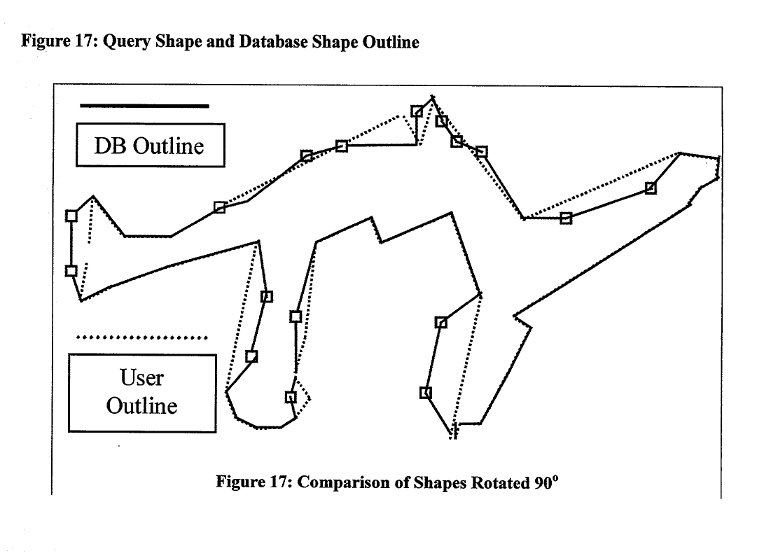

3. The comparison of the two outlines is provided in FIG. 17, rotated clockwise at 90°.

The solid line represents the more exact shape stored in the database and the dotted line is the user's approximate view. The goal is to get a good similarity match Note that the pictures contain a circumscribing circle, which touches the figure at a maximum and minimum in the vertical direction (the use of this circle is important). To overcome the problems of mismatch a new process is introduced, using a concept is taken from differential geometry, the part of mathematics that deals with curved lines and (hyper)surfaces in space.

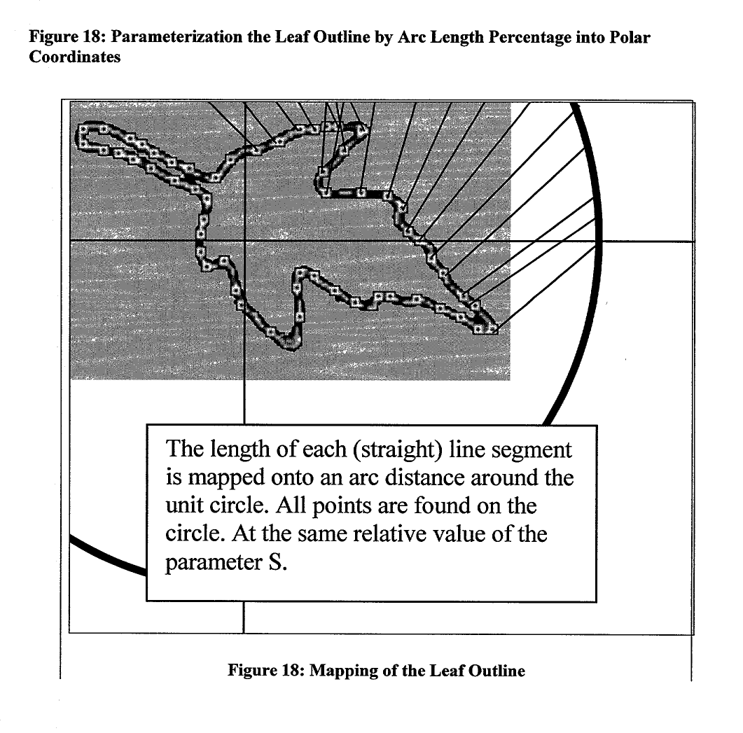

The shape is a curve in space. The points of inflection represent points of approximation to this continuous curve. Starting at a point on the unit circle it is possible to map each line segment to a curved line, an arc on the unit circle. This is done by creating a vector function X(s)=(x,y) in 2 dimensional space, where s is the normalized length of the polygon. The arc subtended between two points represents the percentage of the curve traversed. This curve is guaranteed to exist if the sides of the polygon do not cross one another, because the mathematics of topology says that it can be deformed continuously to any closed curve, like the unit circle. This is illustrated in FIG. 18, using the leaf outline from FIG. 17. The mapping so defined, however, is far from unique.

To improve on this situation further processing is done

1. Convert the lines between points to continuous curves using splines. Use 3 point splines for nearly linear sections increasing up to 8 points splines to get a distance from the curve to the line being approximated that is equal to the minimum distance between the 3 point splines and the straight line segments.

2. Create Polar Indexes of curved approximation sto the outlines vs. the those of the shapes in the database and the query, to those of the continuous curve approximation, and create trangularizations to the curved outline shapes.

Explanation: The process is applied to take the line regular curves in the plane. First the points in the representation are converted to an approximation by a continuous polynomial function using splines (creating curves of a polynomial of a given degree that will fit the points chosen). This gives us the property that continuous second derivatives exist. Because the arc-length is used as a parameter, the vector magnitude of the derivative is always =1. Let its direction relative to the coordinate system in which the image was processed be the angle θ. Then the arc X(s) maps to the unit circle.

2.3 The Non Convex Case is Handled Too

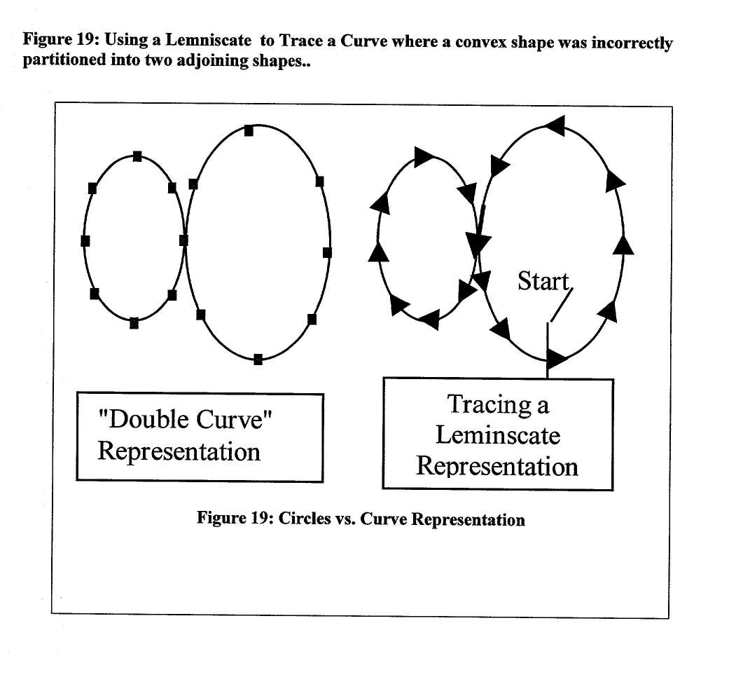

If the points in one image are too small to be distinguished because of scale the rest of the points then there is a danger that in narrow areas, say neck of the skater, then this mapping has a further value. This mapping allows the creation of the circular image as a function of the angle, θ(s). This function, of course, may go in more than one direction, i.e. is non-monotonic, in two dimensional space while being single valued in its parameter. Using this mapping even crossover points can be handled. When two close points in an image would appear as one other shape detection algorithms would create an image having two shapes, the double circles on the left side of FIG. 19. Using the above described circular image mapping, however, the curve outlines one object, by tracing out the form of a leminiscate (i.e. a “figure-8”).

With θ(s) being defined, the curvature κ of the arc is also defined as the derivative of this function dθ(s)/ds. Details may be found in [Stok 69]. This function and its derivative dκ(s)/ds allow one to define a state vector for the curvature (position and velocity). By finding the points that the curvature's derivative dκ(s)/ds=0 (the second derivative of θ(s)), we find the local maximum and minimum curvature values. Of interest then is the magnitude of the state vector's points of local maxima and minima. By ranking them we now have an index vector that allows partial matches. This provides an index that allows data mining algorithms of a clustering variety to be applied to the data. Because the user and the database's curves of shape will be close, the user should locate the database image using this technique. Additional indexes may be uncovered by further research. So the advantage is that small images can still be represented in this technique where they would be lost with the histogram technique.

### 6.0 REFERENCES

[AhG97] I. Ahmad and W. I. Grosky, “Spatial Similarity-Based Retrievals and Image Indexing by Hierarchical Decomposition,” Proceedings of the International Database Engineering and Application Symposium, Montreal, Canada, August 1997, pp. 269-278.

[ATY95] Y. A. Aslandogan, C. Their, C. T. Yu, and C. Liu, “Design, Implementation and Evaluation of SCORE (a System for Content based Retrieval of pictures), Proceedings of the 11^{th} IEEE International Conference on Data Engineering, Taipei, Taiwan, March 1995, pp. 280-287.

[BPS94] A. Del-Bimbo, P. Pala, and S. Santini, “Visual Image Retrieval by Elastic Deformation of Object Shapes,” Proceedings of the IEEE Symposium on Visual Languages, October 1994, pp. 216-223

[ChG96] .Chaudhuri and L. Gravano, “Optimizing Queries over Multimedia Repositories,” Proceedings of SIGMOD ''96, Montreal, Canada, June 1996, pp. 91-102.

[ChW92] C.-C. Chang and T.-C. Wu, “Retrieving the Most Similar Symbolic Pictures from Pictorial Databases,” Information Processing and Management, Volume 28, Number 5 (1992), pp. 581-588.

[CSY86] S.-K. Chang, Q.-Y. Shi, and S.-W. Yan, “Iconic Indexing by 2D Strings,” Proceedings of the IEEE Workshop on Visual Languages, Dallas, Tex., June 1986, pp. 12-21.

[DuH73] .O. Duda and P. E. Hart, Pattern Classification and Scene Analysis, John Wiley and Sons, Inc., New York, N.Y., 1973.

[GrJ94] W. I. Grosky and Z. Jiang, “Hierarchical Approach to Feature Indexing,” Image and Vision Computing, Volume 12, Number 5 (June 1994), pp. 275-283.

[Gro97] W. I. Grosky “Managing Multimedia Information in Database Systems,” Communications of the ACM, Volume 40, Number 12 (December 1997), pp. 72-80.

[ChL84] S.-K. Chang and S.-H. Liu, “Picture Indexing and Abstraction Techniques for Pictorial Databases,” IEEE Transactions on Pattern Analysis and Machine Intelligence, Volume 6, Number 4 (July 1984), pp. 475-484.

[GFJ97] W. I. Grosky, F. Fotouhi, and Z. Jiang, “Using Metadata for the Intelligent Browsing of Structured Media Objects,” In Managing Multimedia Data: Using Metadata to Integrate and Apply Digital Data, A. Sheth and W. Klas (Eds.), McGraw Hill Publishing Company, New York, 1997, pp. 67-92.

[Gud95] V. Gudivada, “On Spatial Similarity Measures for Multimedia Applications,” Proceedings of IS&T/SPIE: Storage and Retrieval for Image and Video Databases III, San Jose, Calif., February 1995, pp. 363-372.

[HSE95] J. Hafner, H. S. Sawhney, W. Equitz, M. Flickner, and W. Niblack, “Efficient Color Histogram Indexing for Quadratic Form Distance Functions,” IEEE Transactions on Pattern Analysis and Machine Intelligence, Volume 17, Number 7 (July 1995), pp. 729-736.

[HuJ94] P. W. Huang and Y. R. Jean, “Using 2D C⁺-Strings as Spatial Knowledge Representation for Image Database Systems,” Pattern Recognition, Volume 27, Number 9 (1994), pp. 1249-1257.

[MPE97] http://mpeg.telecomitalialab.com/standards/mpeg-7/mpeg-7.htm

[Oro94] J. O“Rourke, Computational Geometry in C, Cambridge University Press, Cambridge, England, 1994.

[SmB95] S. M. Smith and J. M. Brady, SUSAN—A New Approach to Low-Level Image Processing, Technical Report TR-95SMS1c, Department of Clinical Neurology, Oxford University, United Kingdom, 1995.

[Stok 69] J. J. Stoker, “Differential Geometry”, Wiley Interscience, New York 1969

[Sub 98] V. S. Subrahmanian, “Principles of Multimedia Database Systems”, Morgan Kaufman, 1998

[WMB94] I. H. Witten, A. Moffat, and T. C. Bell, Managing Gigabytes, Van Nostrand Reinhold, New York, N.Y., 1994.

I claim:

1. The invention shown and described.
